(19) United States
(12) Patent Application Publication
(10) Pub. No.: US 2011/0140907 A1
(43) Pub. Date: Jun. 16, 2011

(54) DOWNHOLE COMMUNICATION

(75) Inventor: Andrew Louden, Aberdeen (GB)

(73) Assignee: SABER LIMITED, Aberdeen (GB)

(21) Appl. No.: 13/057,009

(22) PCT Filed: Jul. 30, 2009
(86) PCT No.: PCT/GB2009/001872

§ 371 Date: Feb. 1, 2011

(30) Foreign Application Priority Data
Aug. 1, 2008 (GB) GB0814095.6

(51) Int. Cl. G01V 3/00

(52) U.S. Cl. 340/854.3

(57) ABSTRACT

A downhole system (10) comprises a tool (16) suspended on a reelable support (18). The support (18) has an optical fibre and the tool communicates with a surface controller via the fibre. The tool (16) has a number of units (24,16a,16b,16c), the unit (24) functioning as a router to transmit and receive signals to and from the other units (16a,16b,16c) and the surface controller via the optical fibre. Each of the units (24,16a,16b,16c) is assigned a unique address which permits secure communication between each unit (24,16a,16b,16c) and the controller over the fibre.

### FIELD OF THE INVENTION

The present invention relates to communication between one or more downhole tools and a controller via a reelable support.

### BACKGROUND OF THE INVENTION

In industries in which holes or bores are drilled in the earth, such as the oil and gas industry, it is well known to run tools and devices into a bore on a reelable support such a slickline, wireline or coiled tubing. The tool may take the form of a surface powered sensor, and there may be real time communication between the sensor and a signal processor on surface. Alternatively, the tool may be self-contained and the tool may, for example, include a power supply, a memory device and/or have data recording capability.

U.S. Pat. No. 4,137,762 discloses various forms of wireline, including one form in which a fibre optic “conductor” is provided within a slick metal sheath, without any conventional metal conductors being present in the wireline. The slick wireline serves to transmit signals between a downhole tool and aboveground equipment. European Patent Application EP 0047704 describes use of logging cables with fibre optic signal conductors, with the optic source and detector at the surface being mounted in, and rotating with, the winch drum. Electrical signals communicate between a non-rotating control/processing unit and the optic source and detector on the winch drum. U.S. Pat. No. 7,140,435 and UK Patent GB 2 392 462 B describe uses of a slickline including a fibre optic line but with no electrical conductor. A manufacturing method for a support as described in these documents, having a slick metal sheath and containing one or more optical fibres, is described in U.S. Pat. No. 4,852,790.

### SUMMARY OF THE INVENTION

According to a first aspect of the present invention there is provided a method of communicating with a downhole tool, the method comprising:

assigning unique addresses to a plurality of downhole tools, at least one of the tools configured to function as a router;

mounting the tools on a reelable support including an optical fibre and locating the tools in a bore;

mounting a surface controller on a winch drum associated with the reelable support; and

transferring data between at least one of the tools and the surface controller via the optical fibre during operation of the winch.

According to a second aspect of the present invention there is provided a downhole system comprising:

a plurality of downhole tools adapted to be assigned a unique address, at least one of the tools configurable to function as a router;

a reelable support including an optical fibre;

a surface controller mountable on a winch drum associated with the reelable support;

a transmitter associated with one of the tools and the surface controller; and

a receiver associated with the other of the tools and the surface controller, whereby data may be transferred between at least one of the tools and the surface controller via the optical fibre during operation of the winch.

The surface controller may encompass any control unit, processing unit or processor. For example, the surface controller may send or receive and process measurement information or other data sent to or from the tools via the optical fibre. Alternatively, or in addition, the surface controller may control one or more of the operations of the tools and/or the winch associated with the reelable support.

In particular embodiments, the surface controller may also be assigned a unique address and the unique addresses assigned to the tools and/or the surface controller may be transferred with the data.

The provision of unique addresses for one or more of the tools and surface controller facilitates provision of “off-the-shelf” systems for running, monitoring and/or controlling downhole tools on a support such as a slick or braided wireline incorporating at least one optical fibre.

This contrasts with existing systems in which a slickline winch/drum is typically only used for the deployment of a solid steel or alloy wire “reelable support” on which mechanical tools are attached.

The method may further comprise transferring the data via the tool configured to function as a router (the “router”). The router may comprise any suitable tool, including for example, but not exclusively, a repeater, a switch, a router or computer.

The method may comprise communicating the data in real time.

Existing systems for running tools which communicate to surface in real time are typically bespoke systems which cannot be easily adapted to accommodate alternative tools. Of course, memory tools, in which data is stored in a memory device in the tool, may be run on any form of support, but suffer from many disadvantages compared to tools providing real time communication.

The unique addresses may be assigned at any suitable time. For example, a supplier may provide customers with complete systems, including tools and controllers, the tools, the routers and the controllers being provided with pre-assigned addresses. Alternatively, the supplier may provide a customer with elements of the system, for example the router, the reelable support and the controller. The controller may be provided with an internal database including predetermined addresses for a range of known tools likely to be used by the customer, and the appropriate address may be assigned to the tools when the system is first set up in the field. If appropriate for the system, only the tools may be assigned an address. The same models of tools or controllers may be assigned the same address, or individual tools or controllers may be assigned unique addresses.

The addresses may be Internet Protocol (IP) addresses, and the system may include a secure downhole IP network.

The tools may be run into the bore on the reelable support, which may comprise a slickline or other suitable support. The provision of multiple tools with individual addresses facilitates running and communicating with the tools on a single support, and facilitates communication between the controller and the tools via a single communication link, for example a single fibre optic conductor.

The tools may be coupled with the optical fibre in parallel or in series. The tools may be physically coupled or connected by an appropriate signal carrying member, or may communicate using a wireless system, for example electromagnetically, acoustically or by a radio frequency protocol such as Bluetooth. The signal carrying member may permit data to be transferred to the tool configured to function as a router and bypass the at least one other tool. The signal carrying member may permit data to be transferred to the tool configured to function as a router wirelessly and bypass the at least one other tool. Alternatively, the signal carrying member may comprise a cable for transferring data to the tool configured to function as a router and bypass the at least one other tool. In particular embodiments, the signal carrying member may comprise a telemetry crossover.

The router may receive data from one or more of the other tools and pass this data to another tool and/or process the data. This may be done without communicating to surface.

The communication between each of the tools and the controller may be one-way, but is preferably bi-directional. For example, the tool may be a sensor which is dormant until activated by an appropriate signal from the controller. The sensor may then collect and transfer data to the controller. The controller may subsequently deactivate the sensor.

The controller is located on surface, which may be subsea, on or adjacent to the winch drum for the reelable support. Alternatively, at least part of the controller may be remotely located. The controller may include a plurality of separate elements and an element of the controller may, for example, be provided on a slickline or wireline rig or truck, providing the rig operator with access to information derived from the tool. In addition, the same or different information may be transmitted to a remote element of the controller. For example, the system or elements of the system may be rented from a supplier, and the supplier may monitor the use of the tool remotely, to ensure that, for example, the tool is serviced at appropriate intervals, or to provide remote diagnostics for the optical fibre or the tool.

The communication between the tools and the controller may be solely via optical fibre, but may be via additional media, for example electrical signals, wireless signals or the like. Appropriate routers or converters may be provided between the different communication media. Typically, one or more of the tools will create electrical signals which are converted to optical signals at a router, optical crossover, electro-optical transceiver or electro-optical media converter for transmission to surface though the optical fibre. Communication between the tools and the converter may be via a hard link, or may be via a wireless link, which simplifies making up a combination tool string from more than one supplier. As noted above, at present conventional downhole tools adapted for mounting on reelable supports tend to create electrical signals, however the use of tools which transmit or receive data in an optical format is within the scope of the present invention.

The use of a reelable support will typically require communication of data between the winch-mounted rotateable reel, such as a slickline or wireline reel, and a non-rotateable controller element. This may be achieved by means of an appropriate slip ring, but is preferably achieved by means of a non-contact communication, such as wireless communication. An appropriate converter and transmitter element of the controller may be provided on the rotateable reel, and an appropriate receiver provided in association with the non-rotating element of the controller. In one embodiment, the surface controller may include a number of elements including a computer mounted inside the winch drum with a wireless link to an adjacent wireless router which can then be interrogated with a computer, such as a laptop computer. The computer or laptop may be hard wired to the router or may communicate with the router wirelessly.

At least one of the tools and the surface controller may comprise a power source and is at least partly self-powered, that is the power supply is not provided with a power supply from surface, or each tool may include an appropriate power source, such as a battery or a source of chemical energy, or may include a power generator using ambient energy, for example a turbine which generates electricity from fluid flowing through the bore, a generator which uses ambient pressure or heat, or a generator which utilises chemical reaction or other interaction with ambient fluids.

In particular embodiments, the surface controller and the router may be battery powered. The reelable support may also comprise a power source, such as a battery.

The provision of a power source, such as battery power, assists in acquiring and delivering data whilst deploying and/or retrieving the reelable support. This contrasts with existing systems, such as for distributed measurements, where data is not transmitted until the support has been deployed and is stationary.

Alternatively, or in addition, power may be supplied from surface. For example, electrical power may be supplied via electrical cabling, or optical power may be supplied via the optical fibre, or an alternative source such as vibration or heat energy may be utilised. Alternatively, a wireless power supply may be utilised.

The tools may take any appropriate form, and may be a sensor, or a completion or intervention tool. The tools may be operated in combination. For example, a sensor may be utilised to facilitate accurate location of the tools in a bore relative to a profile. Another tool may then be activated from surface to extend a dog, anchoring device or other member to engage the profile and lock the tools in position.

Although the invention is described primarily with reference to downhole applications, those of skill in the art will recognise that the system may also be utilised in pipelines, risers and the like.

Many of the features described above have utility independently of the aspects described above and may themselves form alternative aspects of the present invention.

According to a further aspect of the present invention there is provided a method of communicating with a downhole tool, the method comprising:

assigning an IP address to a downhole tool;

mounting the tool on a support and locating the tool in a bore; and

transferring data containing the address between the tool and a downhole router and a surface controller.

According to a still further aspect of the present invention there is provided a downhole system comprising:

a downhole tool adapted to be assigned an IP address;

a tool controller; a transmitter associated with one of the tool and the controller; and

a receiver associated with the other of the tool and the controller, whereby data may be transferred between the tool and the controller.

It will also be understood that the system according to any one of the aspects of the present invention may comprise a modular system and that elements of the invention may be provided or supplied separately or in sub-assemblies comprising two or more of the parts of the system.

### BRIEF DESCRIPTION OF THE DRAWING

These and other aspects of the present invention will now be described, by way of example only, with reference to the accompanying drawings, in which:

FIG. 1 is a schematic representation of a downhole communication system in accordance with an embodiment of the present invention;

FIG. 2 is a diagrammatic representation of a downhole tool in accordance with an embodiment of the present invention;

FIG. 3 is an enlarged view of a media converter/IP router of the tool of FIG. 2;

FIG. 4 is an enlarged view of a telemetry crossover of the tool of FIG. 2; and

FIG. 5 is a diagrammatic representation of a downhole tool in accordance with an alternative embodiment of the present invention.

### DETAILED DESCRIPTION OF THE DRAWING

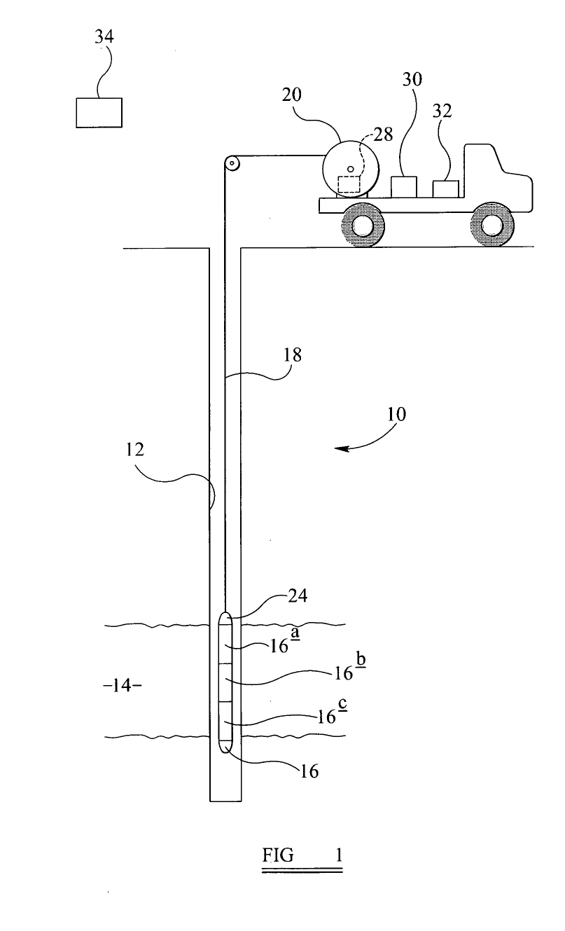

FIG. 1 illustrates a system 10 in accordance with an embodiment of the invention. A bore 12 has been drilled to access a subsurface formation 14 and a tool 16 is being utilised to, among other things, obtain information on the formation 14. The tool 16 is suspended on a reelable support 18 comprising at least one fibre optic conductor encased within a slick sheath. The upper end of the support 18 is coiled around a winch drum 20. As will be described, the tool 16 communicates with a surface controller via the fibre optic conductor.

The tool 16 comprises a number of self-powered units 16a, 16b, and 16c. The units may take different forms and, for example, measure different parameters of the formation 14, capture fluid samples, or function as intervention units, for example a running or retrieval tool with an isolation plug. The units 16a, 16b, 16c may be in wired or wireless communication with a media converter and IP router which transmits and receives signals to and from the units 16a, 16b, 16c. In the embodiment shown, the router comprises an electro optical media converter and IP router 24 and comprises a cable head tool with data transmission and processing capabilities.

The units 16a, 16b and 16c are each assigned a unique IP address and the data transmitted and received includes the respective address, and also IP addresses for the router 24 and a surface controller, as described below.

Optical signals corresponding to data generated by the units 16a, 16b and 16c are transmitted from the router 24 through the fibre optic conductor to surface.

In this embodiment, the surface controller includes a number of separate elements, including an optical transceiver and computer 28 mounted within the winch drum 20, the computer 28 being in wireless communication with an adjacent wireless router 30, which router 30 is interrogated by a wireless computer 32, such as a laptop computer. Thus, the optical signals are converted and processed by the computer 28, and may then be analysed by an operator using the computer 32. Further, data may also be transmitted to and received from a remote location, for example a control centre 34.

The operator may assign secure control of the individual units 16a, 16b and 16c using the computer 32 to other wireless computers operated by the tool owners.

A principal advantage of this embodiment of the present invention is that the multiple tool units 16a-c are assigned unique IP addresses and can operate and communicate independently of one another, via a common communication media, with a single surface controller. The tool units may be replaced and supplemented with other units as desired by the operator, providing greatly enhanced flexibility.

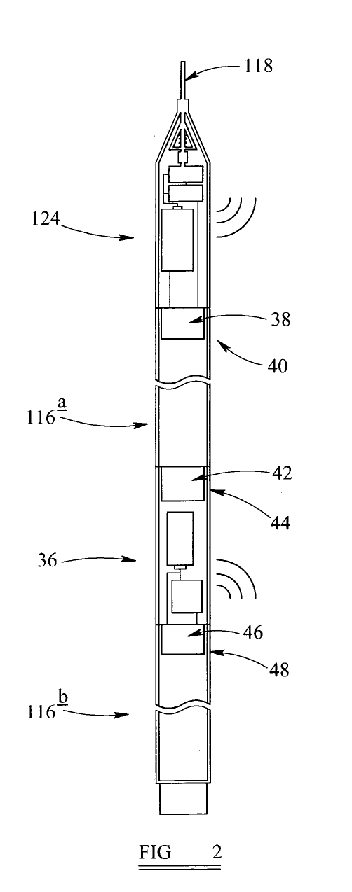

FIG. 2 shows a tool 116 according to an embodiment of the present invention and the tool 116 may, for example, be used in a downhole system such as the system 10 shown in FIG. 1. Like components between FIG. 1 and FIG. 2 are indicated by like reference numerals incremented by 100.

The tool 116 comprises two units 116a, 116b in communication with a battery powered electro-optical media converter/IP router/cable head 124. While two units 116a, 116b are shown in FIG. 2, it will be readily understood that any number of units 116a, 116b, . . . 116n may be provided. A telemetry crossover 36 is provided between the tools 116a, 116b and, in use, the crossover 36 permits independent and secure communication between each tool 116a, 116b, and the media converter/IP router 124 using wireless means.

The media converter/IP router 124 comprises a pin connector 38 for engaging with a corresponding box connector 40 coupled to, or formed in, the first unit 116a. In a similar manner, a distal end of the first unit 116a comprises a pin connector 42 for engaging with a corresponding box connector 44 coupled to, or formed in, the telemetry crossover 36. A distal end of the telemetry crossover 36 has a pin connector 46 for engaging with a corresponding box connector 48 coupled to, or formed in, the second unit 116b. While the embodiment shown in FIG. 2 shows box and pin connections, it should be recognised that any suitable connection may be used as appropriate, including quick connect couplings and the like. The connectors 38 and 46 can be used to transfer data and/or power to or from the adjacent elements/tools. Although the figures and description detail box and pin connectors, those of skill in the art will recognise that the means by which the tools are connected may take various forms and the tools may be connected within a single tool body.

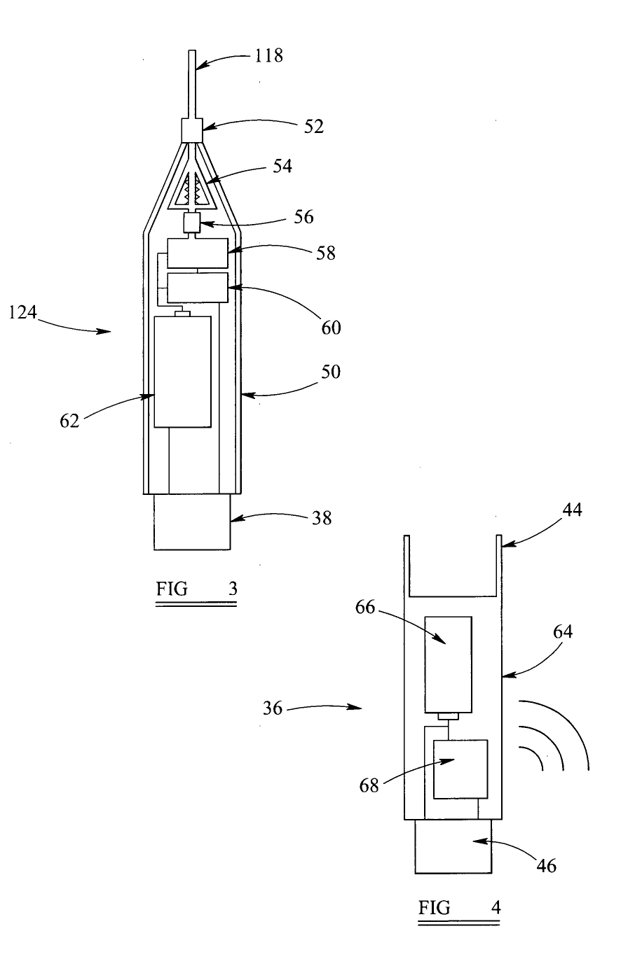

An enlarged view of the electro-optical media converter/IP router/cable head 124 is shown in FIG. 3. In use, the media converter/IP router 124 transmits and receives signals to and from the units 116a, 116b. As shown in FIG. 3, the media converter/IP router 124 has a housing 50 and a hydraulic cable seal 52 is provided on an upper end of the housing 50, the reelable support 118 extending through the seal 52 into the housing 50. The distal end of the reelable support 118 (that is, the end of the reelable support 118 furthest from the controller) is coupled to the housing 50 via an anchoring device 54 and a telemetry connector 56. The telemetry connector 56 is coupled to a signal modulator 58 which in turn is coupled to a router 60. In the embodiment shown, the router 60 comprises a computer, though other repeaters/switches/routers, including wireless capable types may be used. Each of the signal modulator 58 and the router 60 are coupled to a power source 62, such as a battery power source, and the power source provides electrical power to the components of the media converter/IP router 124.

In use, each of the units 116a, 116b communicates with the media converter/IP router 124. The unit 116a may communicate directly with the media converter/IP router 124 via the pin 38 and box 40 connection. The unit 116b communicates wirelessly with the media converter/IP router 124 via the telemetry crossover 36. In the embodiment shown, the unit 116b is coupled to the crossover 36 by the pin 46 and box 48 connection and the crossover 36 communicates wirelessly with the media converter/IP router 124.

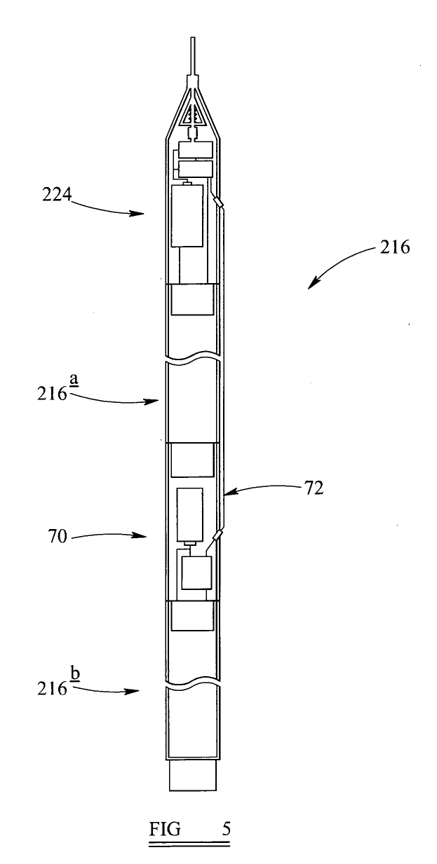

An enlarged view of the telemetry crossover 36 is shown in FIG. 4. The telemetry crossover 36 comprises a housing 64 having a power supply in the form of battery 66 coupled to a data receiver/transmitter 68 for receiving signals from the unit 116b and transmitting these signals wirelessly to the media converter/IP router 124.

FIG. 5 shows a tool 216 according to an alternative embodiment of the present invention and the tool 216 may, for example, be used in a downhole system such as the system 10 shown in FIG. 1. For convenience, like components between FIG. 1 and FIG. 5 are indicated by like reference numerals incremented by 200.

The tool 216 comprises two units 216a, 216b in communication with an electro-optical media converter/IP router 224. A telemetry crossover 70 is provided between the units 216a, 216b and, in use, the crossover 70 permits independent and secure communication between each unit 216a, 216b, and the media converter/IP router 224. As shown in FIG. 5, the media converter/IP router 224 is similar to the media converter/IP router 124 but rather than communicating wirelessly, the media converter/IP router 224 communicates with the crossover 70 via a bypass conduit or wire 72 extending down the outside of the tool 216a. As with the tool 116b, the bypass conduit 72 permits communication between the second unit 216b and the media converter/IP router 224 without impinging on the first unit 216a.

It should be understood that the embodiment described herein is merely exemplary and that various modifications may be made thereto without departing from the scope of the invention.

For example, while in preferred embodiments an optical fibre is used, it is envisaged that any suitable data conductor may be used, where appropriate.

While communication between one or more of the tools and the controller may be one-way, for example in relatively simple systems, in particular embodiments of the invention communication between the tool and the controller will be bi-directional.

Furthermore, while the transmission medium discussed above is optical, it will be understood that any suitable medium such as an electrical conductor may be used.

One or more of the media converter/IP router 124, the telemetry crossover 36 and the units 116a, 116b may be self-powered, for example, the media converter/IP router 124 and the telemetry crossover may have onboard power supply in the form of batteries. Alternatively, one or more of the media converter/IP router 124, the telemetry crossover and the units 116a, 116b may be powered by an external power source. For example, the units 116a, 116b may be powered from surface or by the power supply of the media converter/IP router 124 or the telemetry crossover.

1. A method of communicating with a downhole tool, the method comprising:
assigning unique addresses to a plurality of downhole tools, at least one of the tools configured to function as a router;
mounting the tools on a reelable support including an optical fibre and locating the tools in a bore;
mounting a surface controller on a winch associated with the reelable support; and
transferring data between at least one of the tools and the surface controller via the optical fibre during operation of the winch.

2. The method of claim 1, comprising controlling at least one of the tool and the winch with the surface controller.

3. The method of claim 1, further comprising assigning the surface controller a unique address.

4. The method of claim 1, comprising transferring the unique addresses with the data.

5. The method of claim 1, comprising transferring the data via the tool configured to function as a router.

6. The method of claim 1, further comprising communicating the data in real time.

7. The method of claim 1, wherein at least one of the unique addresses is pre-assigned.

8. The method of claim 1, wherein at least one of the unique addresses is assigned when the system is set up.

9. The method of claim 1, wherein the unique address is an Internet Protocol (IP) address.

10. The method of claim 1, further comprising configuring the surface controller to provide for secure data communication with at least one of the tools.

11. The method of claim 1, further comprising configuring the surface controller to provide for secure onward data communication from the surface controller to the tool proprietor.

12. The method of claim 1, comprising running the tools into the bore on the reelable support.

13. The method of claim 1, wherein the reelable support comprises a slickline.

14. The method of claim 1, wherein the winch comprises a slickline winch and the method comprises mounting the surface controller on the winch drum.

15. The method of claim 1, comprising transferring data only via the optical fibre.

16. The method of claim 1, comprising connecting the tools via a signal carrying member.

17. The method of claim 16, wherein the signal carrying member permits data to be transferred to the tool configured to function as a router and bypass the at least one other tool.

18. The method of claim 16, wherein the signal carrying member permits data to be transferred to the tool configured to function as a router wirelessly and bypass the at least one other tool.

19. The method of claim 16, wherein the signal carrying member comprises a cable for transferring data to the tool configured to function as a router and bypass the at least one other tool.

20. The method of claim 16, wherein the signal carrying member comprises a telemetry crossover.

21. The method of claim 1, wherein the tool configured to function as a router transfers data to the at least one other tool without communicating to surface.

22. The method of claim 1, wherein the tool configured to function as a router processes the data.

23. The method of claim 1, wherein at least one of the tools and the surface controller is at least partly self-powered.

24. The method of claim 1, further comprising transferring data while the tools are stationary.

25. A downhole system comprising:
a plurality of downhole tools adapted to be assigned unique addresses, at least one of the tools configurable to function as a router;
a reelable support including an optical fibre;
a surface controller mountable on a winch associated with the reelable support;
a transmitter associated with one of the tools and the surface controller; and
a receiver associated with the other of the tools and the surface controller, whereby data may be transferred between at least one of the tools and the surface controller via the optical fibre during operation of the winch.

26. The system of claim 25, whereby the data is transferred via the tool configurable to function as a router and the optical fibre.

27. The system of claim 25, wherein at least one of the tools and the surface controller comprises a power source and is at least partly self-powered.

28. The system of claim 25, wherein the reelable support comprises a slickline.

29. The system of claim 25, wherein the winch comprises a slickline winch and the surface controller is adapted to be mounted on the winch drum.

30. The system of claim 25, wherein the surface controller is configurable to send and/or receive the data and process the data sent to or from the tools via the optical fibre.

31. The system of claim 25, wherein the surface controller is configurable to control operation of at least one of the tools and the winch associated with the reelable support.

32. The system of claim 25, wherein the surface controller is adapted to be assigned a unique address.

33. The system of claim 25, wherein the unique addresses comprise Internet Protocol addresses.

34. The system of claim 25, wherein the system comprises a secure downhole Internet Protocol (IP) network.

35. The system of claim 25, wherein the tools are adapted to be coupled to the optical fibre in parallel.

36. The system of claim 25, wherein the tools are adapted to be coupled to the optical fibre in series.

37. The system of claim 25, wherein the tools are adapted to be mounted on the reelable support.

38. The system of claim 25, wherein the tools are physically coupled.

39. The system of claim 25, further comprising a signal carrying member for connecting the tools.

40. The system of claim 39, wherein the signal carrying member comprises at least one of a transmitter and a receiver to permit wireless transmission of the data to the tool adapted to function as a router and bypass the at least one other tool.

41. The system of claim 40, wherein the signal carrying member comprises a cable for transferring data to the tool adapted to function as a router and bypass the at least one other tool.

42. The system of claim 39, wherein the signal carrying member comprises a telemetry crossover.

43. The system of claim 39, wherein the signal carrying member further comprises a power source.

44. The system of claim 25, wherein the system is configurable so that communication between the tool and the controller is one-way.

45. The system of claim 25, wherein the system is configurable so that communication between the tool and the controller is bi-directional.

46. The system of claim 25, wherein the data communication between the tools and the controller is solely via the optical fibre.

47. The system of claim 25, wherein the communication between the tools and the controller is partly via the optical fibre and partly via an additional media.

48. The system of claim 47, wherein the additional media comprises electrical signals.

49. The system of claim 47, wherein the additional media comprises wireless signals.

50. The system of claim 25, further comprising an electro-optical converter for converting electrical signals from the tools into optical signals for transmission to surface through the optical fibre.

51. The system of claim 50, wherein the communication between the tools and the electro-optical converter is via a hard link.

52. The system of claim 50, wherein the system is configurable so that the data communication between the tools and the electro-optical converter is via a wireless link.

53. The system of claim 50, further comprising a signal carrying member for connecting the tools and wherein the system is configurable so that the data communication between the tools and the electro-optical converter is transferred via the signal carrying member.

54. The system of claim 25, wherein the tools are configurable to transmit and/or receive optical data.

55. The system of claim 25, wherein the downhole router comprises an anchoring device for securing the reelable support.

56. The system of claim 25, wherein the tool configurable to function as a router comprises a telemetry connector.

57. The system of claim 25, wherein the tool configurable to function as a router comprises a signal modulator.

58. The system of claim 25, wherein the tool configurable to function as a router comprises a repeater/switch/router.

59. The system of claim 25, wherein the tool configurable to function as a router comprises a power source.

60. The system of claim 25, wherein the controller comprises a plurality of separate elements.

61. The system of claim 60, wherein at least one of the surface controller elements is remotely located.

62. The system of claim 60, wherein at least one of the surface controller elements is provided on a rig or truck.

63. The system of claim 25, wherein the surface controller comprises at least one non-rotateable element for providing data communication between a rotatable reel and the reelable support.

64. The system of claim 63, wherein the non-rotateable element comprises a slip ring.

65. The system of claim 63, wherein communication between the rotateable reel and the reelable support is provided wirelessly.

66. The system of claim 63, wherein the controller further comprises converter and transmitter elements provided in association with the rotateable reel and a receiver provided in association with the non-rotating element of the controller.

67. The system of claim 25, wherein the surface controller comprises a computer mounted inside the winch drum.

68. The system of claim 67, wherein the surface controller computer is wirelessly linked to a router in communication with a computer.

69. The system of claim 68, wherein the computer and the router are hard wired.

70. The system of claim 27, wherein the power source comprises a battery.

71. The system of claim 27, wherein the power source comprises a turbine configurable to generate electricity from fluid flowing through the bore.

72. The system of claim 27, wherein the power source comprises a generator adapted to use at least one of ambient pressure, heat, and a chemical reaction with ambient fluids to produce electricity.

73. The system of claim 25, wherein at least one of the tools is at least partly powered from surface.

74. The system of claim 73, further comprising electrical power cabling for providing power to the tool.

75. The system of claim 25, wherein the optical power is supplied via the optical fibre.

76. The system of claim 25, wherein the power is supplied by vibrational energy.

77. The system of claim 25, further comprising a wireless power supply.

78. The system of claim 25, wherein the tool comprises a completion tool.

79. The system of claim 25, wherein the tool comprises an intervention tool.

80. A method of communicating with a downhole tool, the method comprising:
assigning an IP address to a downhole tool;
mounting the tool on a support and locating the tool in a bore; and
transferring data containing the IP address between the tool and a downhole router and a surface controller.

81. A downhole system including:
a downhole tool adapted to be assigned an IP address;
a tool controller;
a transmitter associated with one of the tool and the controller; and a receiver associated with the other of the tool and the controller, whereby data may be transferred between the tool and the controller.
